(19) United States
(12) Patent Application Publication
(10) Pub. No.: US 2011/0242314 A1
(43) Pub. Date: Oct. 6, 2011

(54) IMAGE TAKING SYSTEM

(75) Inventor: Takayuki KIKUCHI, Utsunomiya-shi (JP)

(73) Assignee: CANON KABUSHIKI KAISHA, Tokyo (JP)

(21) Appl. No.: 13/071,107

(22) Filed: Mar. 24, 2011

(30) Foreign Application Priority Data
Mar. 31, 2010 (JP) 2010-083799 (PAT.

(51) Int. Cl. H04N 7/18

(52) U.S. Cl. 348/135; 348/E07.085

(57) ABSTRACT

An image taking system includes: an image taking unit for taking an image of an object; a ranging unit for measuring an object distance to the object in a shooting angle of field of the image taking unit; a turning unit for turning the image taking unit in a pan direction and a tilt direction; a support unit for supporting the turning unit at a predetermined location; a pan/tilt angle detecting unit for detecting a pan angle and a tilt angle of the turning unit; and a distance computing unit for computing a distance between the object and a reference plane, which is a plane including a direction of the optical axis at a predetermined pan angle of the turning unit and a vertical direction, based on the object distance obtained by the ranging unit and the pan angle and the tilt angle obtained by the pan/tilt angle detecting unit.

### BACKGROUND OF THE INVENTION

1. Field of the Invention

The present invention relates to an image taking system, and more particularly, to an image taking system suitable for a sporting event or the like, involving movements of objects.

2. Description of the Related Art

Some conventional video cameras and digital cameras have multiple ranging points in a shooting angle of field, and there is known a technology in which a ranging sensor or the like is used to derive a distance to an object at the ranging point, a defocus amount, and other information to execute autofocus (AF) (see Japanese Patent Application Laid-Open Nos. 2005-173280 and 2008-233896).

Another known technology in a double track race, such as a skating race, is to compute a running distance by analyzing the position of an athlete based on a measured distance and a pan/tilt angle of a distance measurer (see Japanese Patent Application Laid-Open No. 2008-194095).

In the multi-point ranging camera and the lens apparatus disclosed in Japanese Patent Application Laid-Open Nos. 2005-173280 and 2008-233896, an optical system for light beam toward the image pickup element is provided with a separation optical system, and the ranging sensor is used to detect the distance to the object and a defocus state, to thereby perform AF or ranging.

In the running distance image generating apparatus disclosed in Japanese Patent Application Laid-Open No. 2008-194095, another distance measurer is necessary other than the image taking system, and further the athlete position needs to be corrected to a centerline of a course based on information from the distance surveying device.

In this case, on racing broadcast for example, the racehorses freely run the course in different positions, and hence there is a problem of causing a large error when the positions are corrected to the centerline of the course.

Further, an operator who operates another ranging apparatus other than the image taking system was needed.

### SUMMARY OF THE INVENTION

It is an object of the present invention to realize an image taking system suitable for sports broadcast, in particular racing broadcast or track race broadcast, which is capable of displaying a distance to a goal out of an image taking screen as on-screen information, while taking an image of main objects, such as multiple racehorses or athletes, without the need to connect the image taking system to an external device or the like for ranging.

An image taking system according to the present invention includes: an image taking unit for taking an image of an object; a ranging unit for measuring an object distance to the object in a shooting angle of field of the image taking unit; a turning unit for turning the image taking unit in a pan direction and a tilt direction; a support unit for supporting the turning unit at a predetermined location; a pan/tilt angle detecting unit for detecting a pan angle and a tilt angle of the turning unit; and a distance computing unit for computing a distance between the object and a reference plane, which is a plane including a direction of an optical axis at a predetermined pan angle of the turning unit and a vertical direction, based on the object distance obtained by the ranging unit and the pan angle and the tilt angle obtained by the pan/tilt angle detecting unit.

The present invention provides an effect that, on sports broadcast or the like, with an almost usual operation performed by the videographer, the difference in distance between the goal and the main objects, such as athletes, and an estimated arrival time can be computed, displayed, and output.

Besides, in another case of capturing a competition event involving different goal positions, an accurate target distance can also be computed by newly obtaining goal information.

Further, for simple description, attention is paid to the goal line in embodiments of the present invention. However, in a long jump event as another example, by obtaining goal information on a takeoff board, it is possible to compute and output a horizontal distance between a jumping athlete and the takeoff board and a vertical distance of the athlete in the height direction.

Further features of the present invention will become apparent from the following description of exemplary embodiments with reference to the attached drawings.

### BRIEF DESCRIPTION OF THE DRAWINGS

FIG. 1 is a block diagram of an image taking system according to Embodiment 1.

FIG. 2 is a flow chart according to Embodiment 1.

FIG. 3A illustrates an exemplary practice form according to Embodiment 1.

FIG. 3B is an installation overhead view of the image taking system according to Embodiment 1.

FIG. 4A illustrates a distance computing process according to Embodiment 1.

FIG. 4B illustrates the distance computing process according to Embodiment 1.

FIG. 5A is an installation overhead view of an image taking system in an installing condition according to Embodiment 2.

FIG. 5B is an installation overhead view of the image taking system according to Embodiment 2 when a pan angle is initialized.

FIG. 5C is an installation overhead view of the image taking system according to Embodiment 2 when a based (goal) position is configured.

FIG. 6 is a block diagram of the image taking system according to Embodiment 2.

FIG. 7 is a flow chart according to Embodiment 2.

FIG. 8 is a block diagram of an image taking system according to Embodiment 3.

FIG. 9A is an image taking condition image of an electronic viewfinder (EVF) display according to Embodiment 3.

FIG. 9B is an image taking condition overhead view according to Embodiment 3.

FIG. 9C is a multi-point ranging arranging image according to Embodiment 3.

FIG. 10 is a flow chart according to Embodiment 3.

### DESCRIPTION OF THE EMBODIMENTS

Preferred embodiments of the present invention will now be described in detail in accordance with the accompanying drawings.

### Embodiment 1

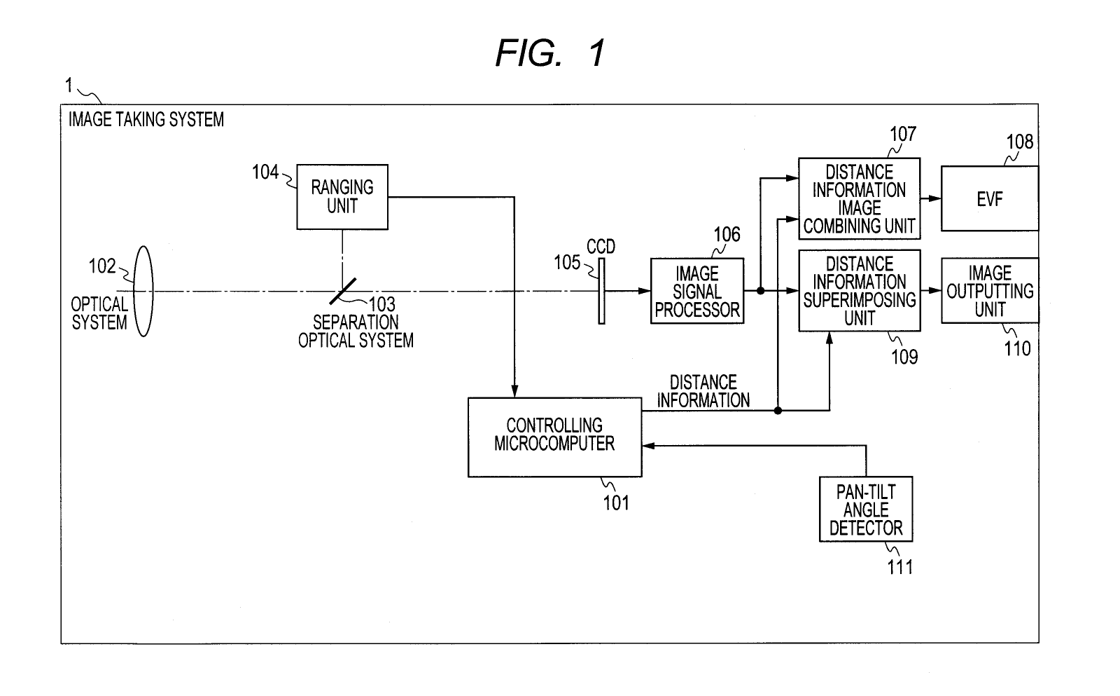

FIG. 1 illustrates a block configuration diagram of an image taking system 1, most clearly illustrating the features of the present invention.

In FIG. 1, the image taking system 1 includes a controlling microcomputer 101 for controlling the overall image taking system 1, an optical system 102, and a separation optical system 103 for separating a light beam for image taking that has passed through the optical system 102. The light beam separated by the separation optical system 103 is further received by a pupil dividing optical system (not shown) as a dual light beam, and forms an image. Based on such dual imaging signal, a ranging unit 104 performs passive ranging at multiple positions in a shooting angle of field by the technology of the phase difference method or the like. Results of the ranging at the respective screen positions obtained by the ranging unit 104 are output to the controlling microcomputer 101.

Another light beam that has transmitted through the separation optical system 103 is received by a charge-coupled device (CCD) 105 to be subjected to photoelectric conversion. An output signal of the CCD 105 is processed into an image signal in an image signal processor 106.

A distance information image combining unit 107 carries out processing of combining the image signal as the output from the image signal processor 106 with distance information supplied from the controlling microcomputer 101. The resultant image signal as the output from the distance information image combining unit 107 is displayed on an electronic viewfinder (hereinafter, referred to as EVF) 108 serving as an image displaying unit. A distance information superimposing unit 109 superimposes the distance information supplied from the controlling microcomputer 101 on the image signal as the output from the image signal processor 106. An image outputting unit 110 outputs the resultant image signal as the output from the distance information superimposing unit 109 to an external device or the like.

The image taking system 1 is mounted onto a camera platform (turning unit) (not shown) which is supported by a support unit (not shown) fixedly installed at a predetermined location. The turning unit is turnable in the pan and tilt directions for pan and tilt operations of the image taking system. The pan angle and the tilt angle of the camera platform, which are image taking angle information of the image taking system 1, are detected by a pan/tilt angle detector 111, and the detected pan and tilt angles are output to the controlling microcomputer 101.

To clearly describe the features of the present invention, an image taking lens is a single focus lens (having a fixed zoom position) having an optical angle of field θL, in which the ranging unit 104 has a single ranging point disposed on the optical axis. Further, the image taking system 1 practically utilizes information from the ranging unit 104 for autofocus, but description of the autofocus is omitted herein because the present invention is directed to a function independently of the autofocus.

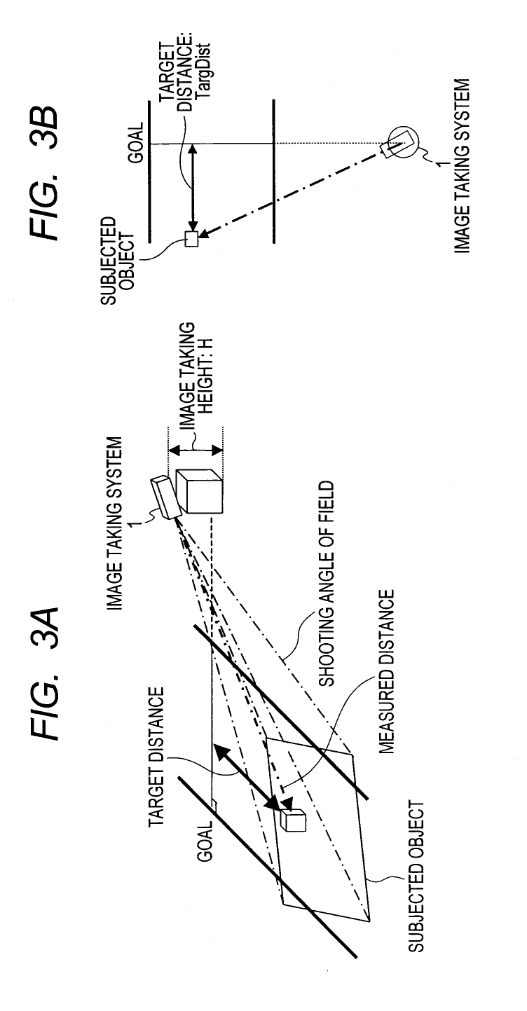

FIGS. 3A and 3B illustrate an image of an image taking condition of the image taking system 1. As illustrated in FIG. 3A, the image taking system 1 is installed at a height H on the extension of a goal line, and takes an image while capturing a subject object at the ranging point on the optical axis. Note that, as illustrated in the installing condition overhead view of FIG. 3B, a based position of the pan angle (angle position at which the pan angle is 0°) is an angle at which the goal line and the optical axis are aligned with each other, on the assumption that the image taking system 1 is disposed on the extension of the goal line. The tilt angle is defined such that an angle at which the optical axis is in the vertical downward direction is a tilt angle of 0°. The present invention has a feature in that the measured distance, the pan angle, the tilt angle, and such image taking system arranging information (i.e., the arrangement on the extension of the goal line) are used to determine a distance between the subject object and the goal as a target distance.

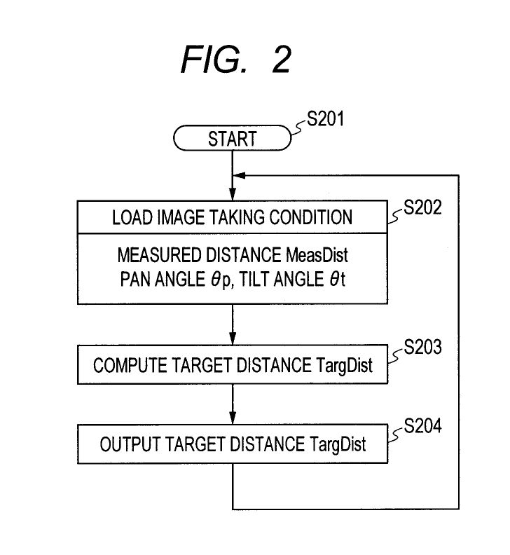

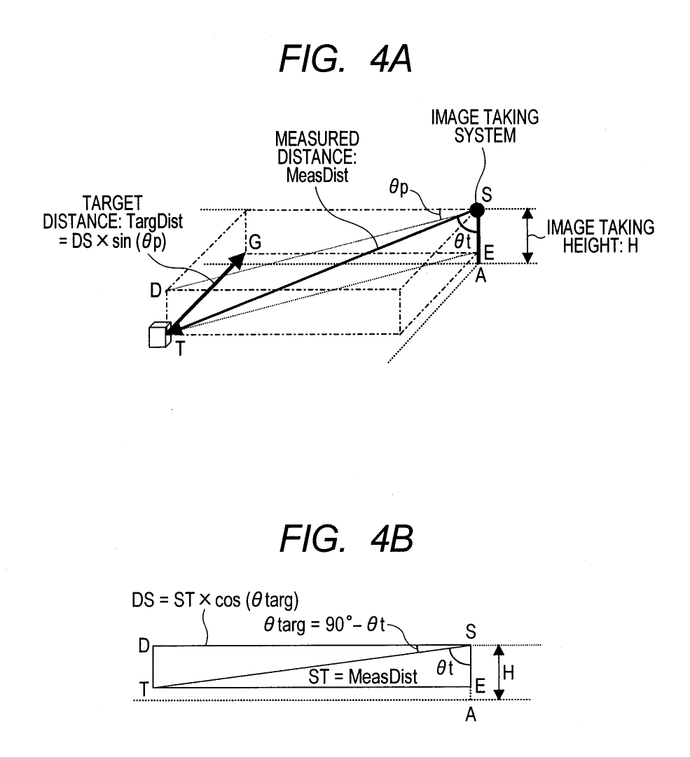

Referring to FIG. 2, an operation flow of the controlling microcomputer 101 in the image taking system 1 configured as above is described. First, the controlling microcomputer 101 starts processing in Processing Step S201 and then loads information on the image taking condition of the image taking system 1 in Processing Step S202. The information to be loaded includes a measured distance MeasDist from the ranging unit 104 and a pan angle θp and a tilt angle θt from the pan/tilt angle detector 111. Then, in Processing Step S203, the obtained information and the known image taking system arranging information are used to compute the distance between the subject object and the goal as a target distance TargDist. This computing method is described with reference to FIGS. 4A and 4B.

FIGS. 4A and 4B are diagrams obtained by extracting the image taking system 1 and the subject object from the image of the image taking condition of FIGS. 3A and 3B and adding pan angle-based auxiliary lines and tilt angle-based of field lines. In FIGS. 4A and 4B, S represents the image taking system, T represents an object, the straight line SE(SA) represents vertical direction and the straight line GE is parallel to the goal line and is on a plane including the goal line and the vertical direction. The line TG is a perpendicular line from the object T to the plane including the goal line and vertical line. First, the loaded tilt angle θt is used to compute an angle θ_{targ} formed by a diagonal ST and a segment SD of a rectangle SDTE.

θ_{targ}=90−θt (1)

Then, the loaded measured distance MeasDist is given as a vector which is determined by the computed angle θ_{targ} which defines the segment ST of FIGS. 4A and 4B, to thereby determine a segment DS and finally compute the target distance TargDist (segment TG shown in FIG. 4A).

$$\begin{matrix}\begin{matrix}DS = MeasDist \times cos ( {θ}_{targ} ) \\ = MeasDist \times sin ( θ t )\end{matrix} & ( 2 ) \\ \begin{matrix}TargDist = DS \times sin ( θ p ) \\ = MeasDist \times sin ( θ t ) \times sin ( θ p )\end{matrix} & ( 3 )\end{matrix}$$

This computation is carried out in Processing Step S203. As a result, in Processing Step S204, the target distance TargDist is output to the distance information image combining unit 107 and the distance information superimposing unit 109, and the processing returns to Processing Step S202. The distance information image combining unit 107 combines the received target distance TargDist with a captured image so as to be displayed on the EVF 108. The distance information superimposing unit 109 superimposes the value of the received target distance TargDist on an ancillary data area of the image signal or the like, and outputs the resultant to the image outputting unit 110.

In the present invention, based on the information of the object distance, the pan angle, and the tilt angle obtained by the image taking system, it is possible to compute a distance between the object and a reference plane, which is a plane including the direction of the optical axis at the pan angle of 0° and the vertical direction (i.e., a distance of the normal to the reference plane from the object).

As described above, the configuration of the present invention enables display of a distance to the goal from an athlete in the event of a competition, even in an image taking condition in which the goal is out of the image taking range. It is therefore possible for the viewer to visually check the distance to the goal on the screen in the event of a competition. The display of the target distance TargDist on the EVF 108 also enables the videographer to grasp the remaining distance to the goal and therefore capture a composition suited to the remaining distance.

The computation from Expressions (1) to (3) for determining the target distance TargDist is merely an example, and another computing method may be used. In this embodiment, the target distance TargDist as the distance between the subject object and the goal is computed, and the resultant information is output and displayed. However, for example, a vector component parallel to the goal (e.g., the length of a segment GE of FIG. 4A) or the height of the subject object (length of a segment EA of FIGS. 4A and 4B) may be computed, and the resultant information may be output and displayed.

In the description above, there is no particular limitation on the method involving loading the image taking system arranging information such as the height H and the based pan and tilt angles θp and θt to the controlling microcomputer 101 of the image taking system 1. For example, the configuration with a configuration switch provided and the configuration through communication to a PC or the like are available.

Further, the image taking system 1 may include an additional unit (arrival time computing unit) for storing the obtained target distance TargDist and determining a difference from a target distance TargDist obtained in the successive processing cycle, that is, determining a time difference therebetween, to thereby compute an arrival time at the goal. Still further, in addition to when the object is moving in perpendicular to the plane (reference plane) including the direction of the optical axis at the pan angle of 0° and the vertical direction, when the object is moving straight, it is generally possible to predict an arrival time of the object at the reference plane by a similar method.

This embodiment pays attention to the goal line in a competition. In a long jump event as another example, by obtaining goal information on a takeoff board, it is possible to compute and output a horizontal distance between a jumping athlete and the takeoff board and a vertical distance of the athlete in the height direction.

It is also possible to stop outputting the target distance TargDist when the goal appears in the image taking range, because whether or not the goal is in the image taking range can be judged at the time of obtaining the goal information based on the relationship between the pan angle θp with respect to the goal and the optical horizontal angle of field θL.

In this embodiment, the image taking system 1 is described, which includes, as the ranging unit, a ranging sensor of a type in which image taking light that has passed through the optical system 102 of the image taking system 1 is separated and used for distant measurement. Even in passive ranging or active ranging using another type of sensor, such as an external measurement sensor, whose image taking optical axis and ranging central axis are not aligned with each other, the target distance TargDist can also be obtained in the same manner by taking parallax into account.

### Embodiment 2

Next, Embodiment 2 is described as another embodiment of the present invention.

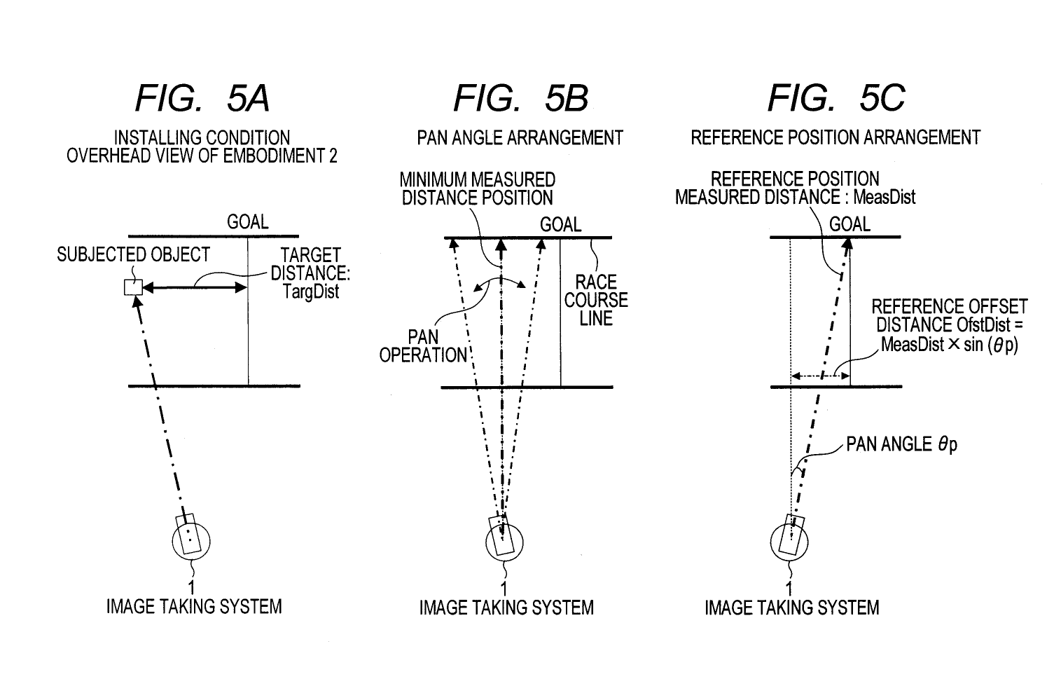

In Embodiment 2, the most characteristic point different from Embodiment 1 is that a distance between a based position (goal) and a subject object can be computed and output to the external device even when the image taking system 1 is not disposed on the extension of a base (goal line). In other words, in Embodiment 1, as illustrated in the installing condition overhead view of FIG. 3B, the image taking system 1 is assumed to be disposed on the extension of the goal line. In this embodiment, on the other hand, as illustrated in FIG. 5A, the arrangement of the image taking system 1 is not limited on the extension of the goal line, and the image taking system 1 can be installed at any location for practical usage.

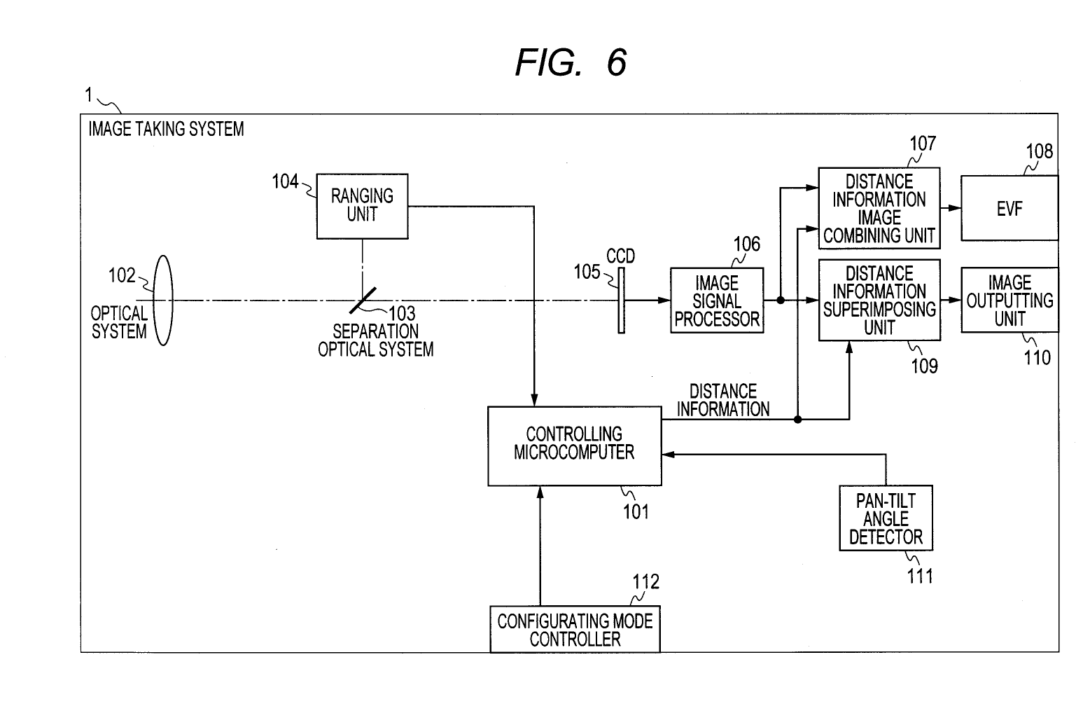

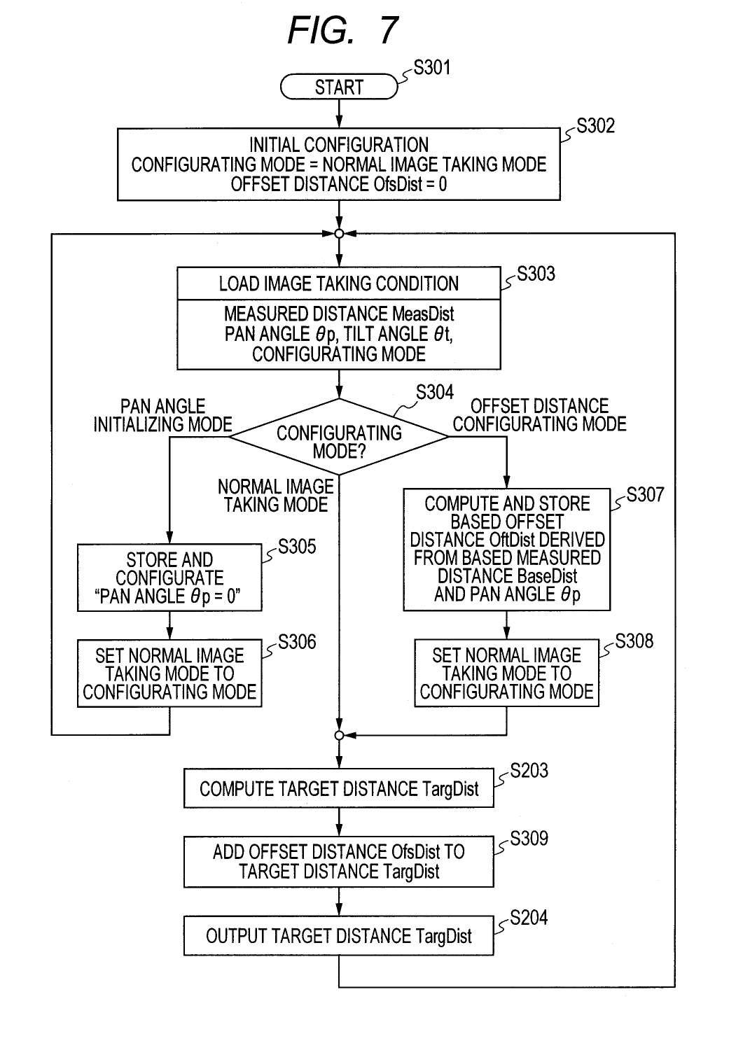

Referring to FIG. 6 illustrating a block configuration of the image taking system 1 and FIG. 7 illustrating an operation flow of the controlling microcomputer, a practical use condition of this embodiment is described. For simple description, the computation for a three-dimensional target distance including the tilt direction as described in Embodiment 1 is omitted below, but the computation for the pan direction is described. In practice, the computation considering the tilt direction is performed similarly to Embodiment 1, and hence a target distance considering the pan angle and the tilt angle can be computed. Description of the same configuration and processing as those of Embodiment 1 is omitted.

As illustrated in FIG. 6, the image taking system 1 according to Embodiment 2 includes, in addition to the configuration of Embodiment 1, a configuration mode controller 112 for performing an initializing operation of identifying the positional relationship between the image taking system 1 and a based position, such as a goal line. An output of the configuration mode controller 112 is supplied to the controlling microcomputer 101. Although the detailed configuration of the configuration mode controller 112 is not illustrated, the videographer can operate the configuration mode controller 112 to freely change a processing flow of the controlling microcomputer 101. The number of operation times and the form of the configuration mode controller 112 are not limited as long as the processing flow of the controlling microcomputer 101 can be changed among the following multiple modes by operating the configuration mode controller 112.

Referring to FIG. 7 illustrating the operation flow of the controlling microcomputer 101, a practice form of the image taking system 1 is described.

First, the videographer performs the initializing operation of configuring the installation relationship between the image taking system 1 and the based position, such as a goal line, to the controlling microcomputer 101 in the image taking system 1. On this occasion, the controlling microcomputer 101 starts processing in Step S301 and performs initial configuration in Step S302. In the initial configuration, the configuration mode is set to a “normal image taking mode”, and 0 is substituted into an offset distance OfsDist.

Next, the processing proceeds to Step S303, and information on an image taking condition of the image taking system 1 is loaded. The information to be loaded includes the measured distance MeasDist from the ranging unit 104 and the pan angle θp and the tilt angle θt from the pan/tilt angle detector 111 similarly to Embodiment 1, and further includes the configuration mode information of the configuration mode controller 112. At this point, the configuration mode is the “normal image taking mode” as an initial condition. Although described in detail later, the modes other than the normal image taking mode are a “pan angle initializing mode” and an “offset distance configuration mode” for recognizing the relationship between the image taking system 1 and the based position.

Subsequently, the processing proceeds to Step S304 and branches after determining which of the configuration modes is being set. Because the current condition is the “normal image taking mode”, the processing proceeds to Step S203. In Step 203, Expression (3) is computed similarly to Embodiment 1. Note that, at this point, a based position of the pan angle is indefinite and hence the target distance TargDist as a result of the computation is also an indefinite value.

Next, in Step S309, a variable value OfstDist is added to the target distance TargDist. Immediately after the start of processing, the target distance TargDist is not changed because the variable value OfstDist is initialized to 0 beforehand in Step S302. The purpose of the variable value OfstDist is clarified in the following description. In Step S204, the target distance TargDist and the measured distance MeasDist are output to the external device of the controlling microcomputer 101, that is, to the distance information image combining unit 107 and the distance information superimposing unit 109. The processing then returns to Step S303.

To store a pan position at which the optical axis of the image taking system 1 intersects perpendicularly with the race course in the controlling microcomputer 101 as a based position of the pan position, the videographer performs the pan operation with the “normal image taking mode” selected, so as to align the image taking optical axis (ranging position) with a position perpendicular to the straight race course line as illustrated in FIG. 5B. On this occasion, the videographer can perform the pan operation to a position having a minimum measured distance MeasDist while checking the measured distances MeasDist which are sequentially obtained in Step S303 and updated and displayed on the EVF 108 as a result.

After completing the operation to the above-mentioned pan position, the videographer operates the configuration mode controller 112 to change the configuration mode from the “normal image taking mode” to the “pan angle initializing mode”. Then, the flow of the controlling microcomputer 101 is shifted from the loop processing to Step S305 as a result of the determination of Step S304. In Step S305, the current pan angle θp is initialized to 0°. The processing then proceeds to Step S306, and the configuration mode is restored to the “normal image taking mode”. As a result, in a subsequent processing flow, the processing returns to the normal condition in which Step S203 is followed by the determination of Step S304.

After completing the initialization of the pan angle, the videographer performs the pan operation again with the configuration mode set to the “normal image taking mode”, so that the image taking optical axis (ranging position) may capture an intersecting position between the race course line and the goal as illustrated in FIG. 5C, while checking the image on the EVF 108.

After completing the pan operation to the above-mentioned pan position, the videographer operates the configuration mode controller 112 to set the configuration mode to the “offset distance configuration mode” from the “normal image taking mode”. Then, the flow of the controlling microcomputer 101 is changed from the loop processing of the normal image taking mode, and proceeds to Step S307 as a result of the determination of Step S304. In Step S307, the current measured distance MeasDist (based measured distance BaseDist) and the pan angle θp, which are obtained in Step S303, are used to compute a based offset distance OfstDist illustrated in FIG. 5C through the following computation.

OfstDist=BaseDist×sin(θp) (4)

As described above, the based offset distance OfstDist is configured to 0 in the initial condition. The value of the based offset distance OfstDist is fixed after the computation of Expression (4). The value of the based offset distance OfstDist is added to the value of the target position TargDist of Embodiment 1, to thereby obtain a distance between the subject object and the goal in Embodiment 2. The addition processing is carried out in Step S309 in the “normal image taking mode”. After the based offset distance OfstDist is computed, in Step S308, the configuration mode is restored to the “normal image taking mode”. Then, in a subsequent processing flow, the processing proceeds to Step S203 followed by the determination of Step S304, and returns to the normal image taking condition.

Such configuration of the image taking system 1 enables the target distance to be computed even if the image taking system 1 and a target index of a main object, such as a goal, have a positional relationship in which the image taking system 1 is not orthogonal to the based positions of the pan angle and the tilt angle. This eliminates the limitation on the installing position that the image taking system 1 has to be installed on the extension of a goal line.

Note that, the target distance TargDist computed in Step S309 after the computation of the based offset distance OfstDist is information on a correct distance from the subject object to the goal line. Embodiment 2 is described by way of example, where the target distance TargDist is output to the external device from the controlling microcomputer 101 even until the based offset distance OfstDist is computed. Alternatively, output inhibition control may be made so as to inhibit the output of the target distance TargDist until the computation of the based offset distance OfstDist is completed. Further alternatively, a warning may be displayed on the EVF 108 so as to notify the videographer that the based offset distance OfstDist has not been fixed.

The modes for computing the based offset distance OfstDist are described above by using the “normal image taking mode”, the “pan angle initializing mode”, and the “offset distance configuration mode”. In this respect, for example, two modes of the “normal image taking mode” and a “based distance computing mode” may be provided, and the operation of configuring the race course line and the optical axis of the image taking system 1 to be perpendicular to each other and the operation of configuring the intersecting position between the race course line and the goal may be performed in a series of processing. Alternatively, the number of configurable modes may be increased. Similarly to Embodiment 1, the controlling microcomputer 101 of the image taking system 1 may be supplied with information on the installing position of the image taking system 1 from the external device through communication. Further, the order of the two operations for configuration may be interchanged.

Further, how to configure a based pan angle is described by way of example, where the race course line and the optical axis of the image taking system 1 are configured to be perpendicular to each other. However, the present invention is not limited thereto. The based pan angle may be configured by making the race course line and the optical axis of the image taking system 1 parallel to each other.

What is important is that the image taking system 1 can recognize the pan and tilt angle conditions having an orthogonal relationship with the course as their based angles so that orthogonal coordinates can be configured. With this, the pan angle is initialized, which is the assumption for computing the distance between the object and the reference plane, which is a plane including the direction of the optical axis at the pan angle of 0° and the vertical direction (i.e., the distance of the normal to the reference plane from the object), based on the information of the object distance, the pan angle, and the tilt angle obtained by the image taking system. Another important factor in obtaining the based offset distance is that a vector from the image taking system to the ranging point of the based position, such as a goal line, can be resolved into a vector to the orthogonal coordinates.

### Embodiment 3

The most characteristic point of Embodiment 3 according to the present invention is that the ranging unit 104 is constituted by a multi-point ranging sensor capable of ranging in multiple regions on an image taking screen, and that a target distance TargDist is computed for a subject object in a ranging frame designated by the videographer. For simple description, similarly to Embodiment 2, the computation for a three-dimensional target distance including the tilt direction as described in Embodiment 1 is omitted below, but the computation for the pan direction is described.

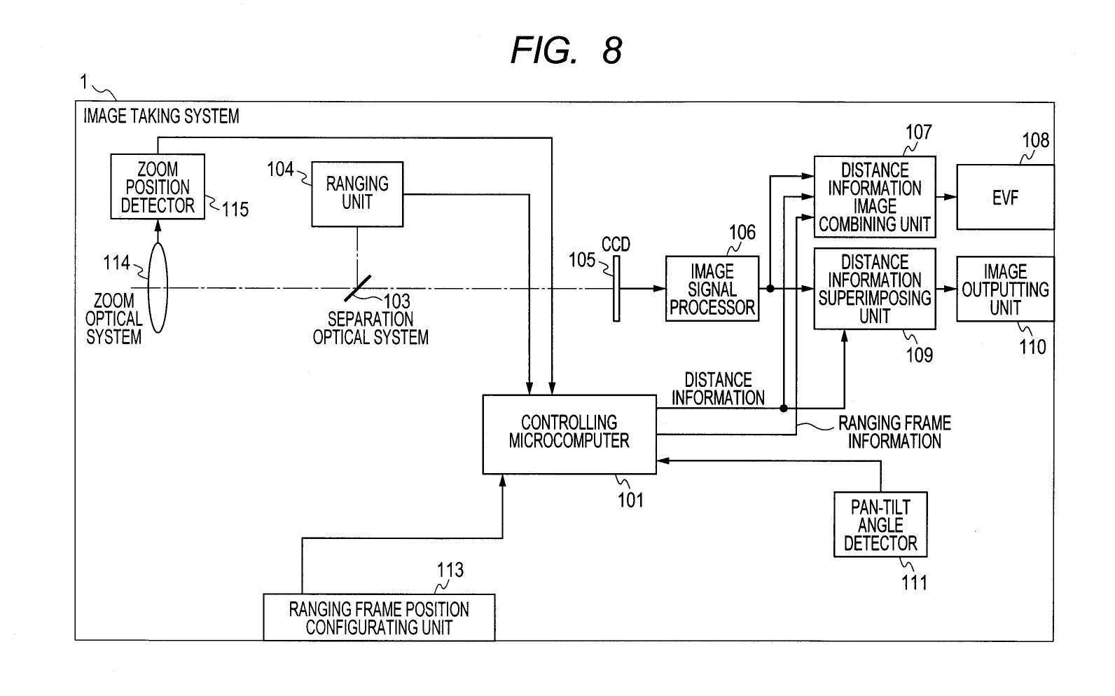

FIG. 8 illustrates a block configuration diagram of an image taking system according to Embodiment 3 of the present invention. In this embodiment, an additional member with respect to the configuration of Embodiment 1 is described. The image taking system 1 of this embodiment includes a ranging frame position configuring unit (ranging frame selecting unit) 113 for allowing the videographer to configure the position of a ranging frame, and also includes a zoom position detector 115 for detecting a zoom position of a zoom optical system 114.

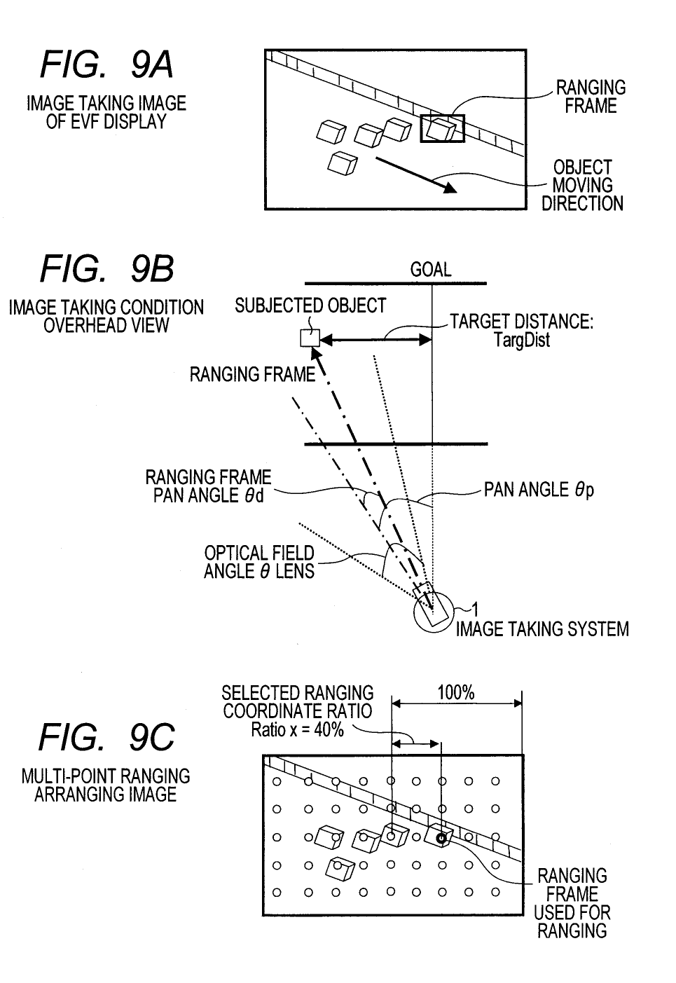

FIG. 9A illustrates a display image of the EVF 108 displaying the ranging frames. In this example, the videographer operates the ranging frame position configuring unit 113 to select one of the multiple ranging frames as a subject ranging frame used for obtaining the target distance TargDist.

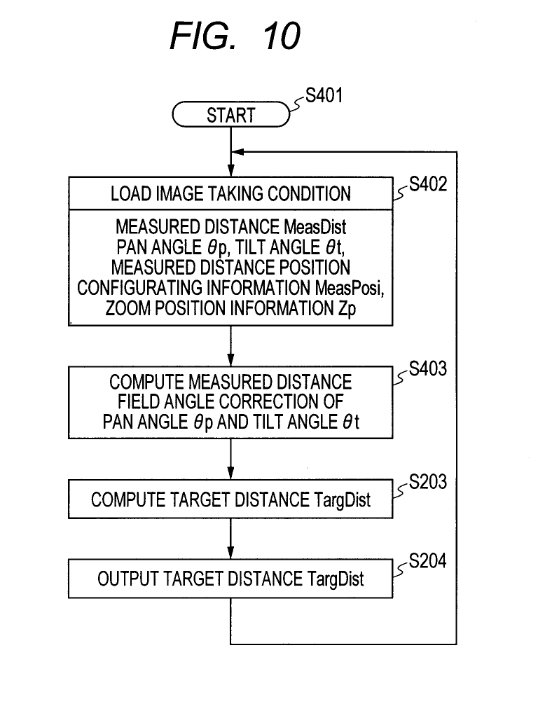

Referring to FIG. 10 illustrating a processing flow of the controlling microcomputer 101, an operation thereof is described.

The processing starts in Step S401, and then in Step S402, information on the image taking condition of the image taking system 1 is loaded. The information to be loaded includes the measured distances MeasDist from all the multi-point ranging sensors of the ranging unit 104, the pan angle θp and the tilt angle θt from the pan/tilt angle detector 109, measured distance position information MeasPosi from the ranging frame position configuring unit 113, and zoom position information Zp from the zoom position detector 115.

Next, in Step S403, based on the obtained measured distance position information MeasPosi and the obtained zoom position information Zp, a ranging frame pan angle θd illustrated in FIG. 9B is computed to carry out computation to correct the pan angle θp. In Embodiment 3, the controlling microcomputer 101 plays a role of computing a correction amount of the pan angle (or tilt angle) for the subject ranging frame with respect to the optical axis direction (i.e. serves as a ranging frame field angle computing unit). The ranging frame pan angle θd is an angle of field at a predetermined position (e.g., the center) in the ranging frame with respect to the optical axis direction of the image taking system 1. First, a current shooting angle of field θₗₑₙₛ is determined. In general, data of angle of field corresponding to each zoom position is stored in advance, and the angle of field θₗₑₙₛ corresponding to the current zoom position information Zp is obtained from the stored value. As illustrated in FIG. 9C, Ratio_x, which is a ratio of a distance from the display center (optical axis center) to the center position of the selected ranging frame to the size of the image taking display in a given position in the display is calculated. Note that, FIG. 9C illustrates an example of Ratio_x of 40% with a distance from the optical axis to the shooting angle-of-field end set to 100%. In other words, the ranging frame pan angle θd is computed by Expression (5).

θd=θₗₑₙₛ×Ratio_{—}x (5)

The ranging frame pan angle θd is added to the pan angle θp to obtain a corrected pan angle θp1.

θp1=θp+θd (6)

After Expression (6) is computed, the processing proceeds to Processing Step S203, and returns to the same processing as that of Embodiment 1.

Herein, for simple description, attention is paid only to the pan direction. However, with respect to the tilt direction, a corrected tilt angle θt1 can also be determined in a similar manner by determining a ranging frame tilt angle and adding the ranging frame tilt angle to the tilt angle θt. Such configuration enables the target distance TargDist to be computed at any ranging position in the shooting field of angle.

Further, in the description above, the measured distance is used only for computing the target distance TargDist, but may be used for automatic focus adjustment processing. In this case, as for a ranging position selected by the ranging frame position configuring unit 113, the automatic focus adjustment and the computation of the target distance TargDist may be performed, or alternatively, another controller may be provided to perform the automatic focus adjustment and the computation of the target distance TargDist at different ranging positions.

Still further, the target distance may be computed for each of multiple measured distances.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In the above described description of the embodiments, the vertical downward direction is defined as the tilt angle being 0° and the extension of the goal line or the direction perpendicular to the race course line is defined as the pan angle being 0°. However, the present invention is not limited thereto. The reference directions for the pan and tilt directions may be defined by predetermined directions. And even in such a case, the same advantageous effect of the present invention can be realized by computing method which is conformity to the references.

This application claims the benefit of Japanese Patent Application No. 2010-083799, filed Mar. 31, 2010, which is hereby incorporated by reference herein in its entirety.

What is claimed is:

1. An image taking system, comprising:
an image taking unit for taking an image of an object;
a ranging unit for measuring a distance to the object in a shooting angle of field of the image taking unit;
a turning unit for turning the image taking unit in a pan direction and a tilt direction;
a support unit for supporting the turning unit at a predetermined location;
a pan/tilt angle detecting unit for detecting a pan angle and a tilt angle of the turning unit; and
a distance computing unit for computing a distance between the object and a reference plane which is a plane including a direction of an optical axis at a predetermined pan angle of the turning unit and a vertical direction, based on the object distance obtained by the ranging unit and the pan angle and the tilt angle obtained by the pan/tilt angle detecting unit.

2. An image taking system according to claim 1, further comprising an arrival time computing unit for computing an arrival time of the object at the reference plane by computing a time difference of the distance obtained by the distance computing unit.

3. An image taking system according to claim 1, further comprising:
an image displaying unit for displaying the image obtained by the image taking unit; and
an image combining unit for combining the distance obtained by the distance computing unit with the image displayed on the image displaying unit, to display the combined image on the image displaying unit.

4. An image taking system according to claim 1, further comprising an image outputting unit for outputting the distance obtained by the distance computing unit to an external device of the image taking system.

5. An image taking system according to claim 1, wherein the distance is computed by
TargDist=MeasDist×sin(θt)×sin(θp),
where TargDist represents the distance, MeasDist represents the object distance, Op represents the pan angle on an assumption that the pan angle is defined as 0° when the optical axis is in the reference plane, and et represents the tilt angle on an assumption that the tilt angle is defined as 0° when the optical axis is in a vertical downward direction.

6. An image taking system according to claim 1,
wherein the ranging unit has multiple ranging frames in the shooting angle of field,
wherein the image taking system further comprises:
a ranging frame selecting unit for selecting an arbitrary ranging frame from the multiple ranging frames as a subject ranging frame; and
a ranging frame field angle computing unit for computing a ranging frame pan angle and a ranging frame tilt angle, which are angles formed between a center of the subject ranging frame and an optical axis in the pan direction and the tilt direction, respectively, and
wherein the distance computing unit computes the distance based on the ranging frame pan angle, the ranging frame tilt angle, a measured distance for the subject ranging frame, the pan angle, and the tilt angle.

7. An image taking system according to claim 6, further comprising:
a zoom optical system for varying the shooting angle of field; and
a zoom position detecting unit for detecting a zoom position of the zoom optical system,
wherein the ranging frame field angle computing unit further computes the ranging frame pan angle and the ranging frame tilt angle by taking into the zoom position into account.

8. An image taking system according to claim 1, wherein a predetermined pan angle of the turning unit is 0°.
